(19) United States
(12) Patent Application Publication
(10) Pub. No.: US 2011/0232276 A1
(43) Pub. Date: Sep. 29, 2011

(54) STIRLING ENGINE AND CONTROL METHOD THEREOF

(75) Inventors: Hiroshi Yaguchi, Toyota-shi (JP); Daisaku Sawada, Gotemba-shi (JP); Masaaki Katayama, Susono-shi (JP)

(73) Assignee: Toyota Jidosha Kabushiki Kaisha, Toyota-shi (JP)

(21) Appl. No.: 13/073,201

(22) Filed: Mar. 28, 2011

(30) Foreign Application Priority Data
Mar. 26, 2010 (JP) JP2010-071644

(51) Int. Cl. F02G 1/053; F01B 31/10

(52) U.S. Cl. 60/517; 92/153

(57) ABSTRACT

A Stirling engine includes a high-temperature side cylinder and an expansion piston that is subjected to gas lubrication, or more specifically static pressure gas lubrication, relative to the high-temperature side cylinder and has a layer on an outer peripheral surface thereof, the layer being formed from a flexible material having a higher linear expansion coefficient than a base material of the expansion piston, wherein a booster pump and a ECU are provided as a contact avoiding device to prevent the expansion piston from contacting the high-temperature side cylinder when an engine operation is stopped until a temperature of the expansion piston can be suppressed below a predetermined value.

### CROSS-REFERENCE TO RELATED APPLICATIONS

This application claims priority to Japanese Patent Application No. 2010-071644 filed on Mar. 26, 2010, which is incorporated herein by reference in its entirety including the specification, drawings and abstract.

### BACKGROUND OF THE INVENTION

1. Field of the Invention

The invention relates to a Stirling engine and a control method thereof, and more particularly to a Stirling engine including a piston that is subjected to gas lubrication relative to a cylinder and has a layer on an outer peripheral surface thereof, and a control method for the Stirling engine.

2. Description of the Related Art

In recent years, Stirling engines exhibiting excellent theoretical thermal efficiency have come to attention with the aim of retrieving exhaust heat from factories and exhaust heat from internal combustion engines installed in vehicles such as passenger automobiles, buses and trucks. High thermal efficiency can be expected of a Stirling engine, and moreover, since a Stirling engine is an external combustion engine that heats a working fluid externally, various types of low temperature difference alternative energy, such as solar energy, geothermal energy, and exhaust heat, can be utilized, enabling energy conservation. Japanese Patent Application Publication No. 2008-267258 (JP-A-2008-267258), Japanese Patent Application Publication No. 2009-121337 (JP-A-2009-121337), Japanese Patent Application Publication No. 2009-85087 (JP-A-2009-85087), and Japanese Patent Application Publication No. 2009-91959 (JP-A-2009-91959), for example, may be considered relevant to the invention since they disclose techniques relating to operation control of a Stirling engine and techniques relating to measures for dealing with foreign matter.

Incidentally, in a Stirling engine disclosed in JP-A-2008-267258, a gas supply for performing gas lubrication is stopped after a piston stops reciprocating. As a result, the piston and a cylinder of the Stirling engine disclosed in JP-A-2008-267258 are prevented from becoming worn. Meanwhile, in a Stirling engine having a piston that is subjected to gas lubrication relative to a cylinder, foreign matter may become interposed between the cylinder and the piston, and when the piston slides via the foreign matter, a surface pressure thereof may increase, causing the foreign matter to agglutinate. As a result, a reduction in performance may occur. However, by providing a layer formed from a flexible material, for example, on an outer peripheral surface of the piston, the foreign matter can be embedded therein such that even if the foreign matter infiltrates or grows, agglutination thereof can be suppressed.

However, a Stirling engine continues to retain a certain amount of received heat even after a heat supply from a high-temperature heat source has been stopped. Therefore, in a Stirling engine having a piston provided with a layer on its outer peripheral surface, similarly to the Stirling engine disclosed in JP-A-2008-267258, the received heat is transmitted to the piston following contact between the piston and the cylinder even when the gas supply for performing gas lubrication is stopped after the piston stops reciprocating, and as a result, the temperature of the layer may exceed a heat resistance temperature, leading to a reduction in the reliability of the piston.

### SUMMARY OF THE INVENTION

The invention provides a Stirling engine in which reliability can be secured in a piston that is subjected to gas lubrication relative to a cylinder and has a layer on an outer peripheral surface thereof when an operation is stopped, and a control method for the Stirling engine.

A first aspect of the invention is a Stirling engine including: a cylinder; a piston that is subjected to gas lubrication relative to the cylinder and has a layer on an outer peripheral surface thereof, the layer being formed from a flexible material having a higher linear expansion coefficient than a base material of the piston; and a contact avoiding device which, when an engine operation is stopped, prevents the piston from contacting the cylinder until a temperature of the piston can be suppressed below a heat resistance temperature of the layer.

In the first aspect of the invention, the contact avoiding device may continue the engine operation using received heat after a heat supply from a high-temperature heat source is stopped until a temperature of the piston following contact with the cylinder can be suppressed below the heat resistance temperature of the layer, and then begin an operation to stop the engine operation such that the piston is caused to contact the cylinder in a state where the engine operation is stopped.

Further, in the first aspect of the invention, the contact avoiding device may continue the engine operation making maximum use of received heat after a heat supply from a high-temperature heat source is stopped, and then begin an operation to stop the engine operation such that the piston is caused to contact the cylinder in a state where the engine operation is stopped and a temperature of the piston following contact with the cylinder can be suppressed below the heat resistance temperature of the layer.

The first aspect of the invention may further include a check valve which, when the piston is subjected to gas lubrication, is capable of performing static pressure gas lubrication on the piston during the engine operation using a pressure of a working fluid in a working space formed in accordance with the piston, wherein the contact avoiding device may continue the engine operation using received heat after a heat supply from a high-temperature heat source is stopped until a temperature of the piston following contact with the cylinder can be suppressed below the heat resistance temperature of the layer, and then begin an operation to stop the engine operation such that the piston is caused to contact the cylinder in a state where the engine operation is stopped.

The first aspect of the invention may further include an estimating device that estimates a temperature of the piston following contact with the cylinder on the basis of an output and a rotation speed prior to the start of an operation for stopping the engine operation.

In the first aspect of the invention, exhaust gas from an internal combustion engine may be used as a high-temperature heat source, and an estimating device that estimates a temperature of the piston following contact with the cylinder on the basis of an average load of the internal combustion engine during a predetermined period prior to stoppage of the internal combustion engine may be further provided.

In the first aspect of the invention, exhaust gas from an internal combustion engine may be used as a high-temperature heat source, and an estimating device that estimates a temperature of the piston following contact with the cylinder on the basis of an average intake air amount of the internal combustion engine or an average flow rate of the exhaust gas during a predetermined period prior to stoppage of the internal combustion engine, and an average temperature of the exhaust gas of the internal combustion engine immediately prior to heat exchange, may be further provided.

An estimating device that estimates a temperature of the piston following contact with the cylinder on the basis of a temperature of a working fluid in a working space formed in accordance with the piston may be further provided.

A second aspect of the invention relates to a control method for a Stirling engine that includes: a cylinder; and a piston that is subjected to gas lubrication relative to the cylinder and has a layer on an outer peripheral surface thereof, the layer being formed from a flexible material having a higher linear expansion coefficient than a base material of the piston. The control method includes: estimating a temperature of the piston attained when the piston contacts the cylinder during an engine operation stoppage, and preventing the piston from contacting the cylinder until the estimated attained temperature of the piston can be suppressed below a heat resistance temperature of the layer.

According to the invention, reliability can be secured in a piston that is subjected to gas lubrication relative to a cylinder and has a layer on an outer peripheral surface thereof when an operation is stopped.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a schematic diagram showing the constitution of a Stirling engine according to a first embodiment;

FIG. 2 is a schematic diagram showing the constitution of a piston/crank unit of the Stirling engine according to the first embodiment;

FIG. 3 a schematic diagram showing the constitution of an Electronic Control Unit (ECU) according to the first embodiment;

FIG. 4 is an illustrative view of a conduction path for heat stored in a heater;

FIG. 5 is a view showing an operation of the ECU according to the first embodiment in the form of a flowchart;

FIG. 6 is a view showing a timing chart corresponding to the operation of the ECU according to the first embodiment;

FIG. 7 is a view showing an operation of an ECU according to a second embodiment in the form of a flowchart;

FIG. 8 is a view showing a timing chart corresponding to the operation of the ECU according to the second embodiment;

FIG. 9 is a view showing an operation of an ECU according to a third embodiment in the form of a flowchart;

FIG. 10 is a view showing a timing chart corresponding to the operation of the ECU according to the third embodiment;

FIG. 11 is a schematic diagram showing the constitution of a Stirling engine according to a fourth embodiment;

FIG. 12 is a view showing an operation of an ECU according to the fourth embodiment in the form of a flowchart;

FIG. 13 is a view showing a timing chart corresponding to the operation of the ECU according to the fourth embodiment;

FIG. 14 is a schematic diagram showing first map data;

FIG. 15 is a view showing a first specific example of a method for estimating a piston temperature following contact with a cylinder in the form of a flowchart;

FIG. 16 is an illustrative view showing an average rotation speed and an average power of a vehicle engine;

FIG. 17 is a schematic diagram showing second map data;

FIG. 18 is a view showing a second specific example of the method for estimating the piston temperature following contact with the cylinder in the form of a flowchart;

FIG. 19 is an illustrative view showing an average intake air amount and an average exhaust gas temperature;

FIG. 20 is a schematic diagram showing third map data;

FIG. 21 is a view showing a third specific example of the method for estimating the piston temperature following contact with the cylinder in the form of a flowchart;

FIG. 22 is an illustrative view relating to a high-temperature side working fluid temperature;

FIG. 23 is a schematic diagram showing fourth map data; and

FIG. 24 is a view showing a fourth specific example of the method for estimating the piston temperature following contact with the cylinder in the form of a flowchart.

### DETAILED DESCRIPTION OF EMBODIMENTS

Embodiments of the invention will be described in detail below using the drawings.

### First Embodiment

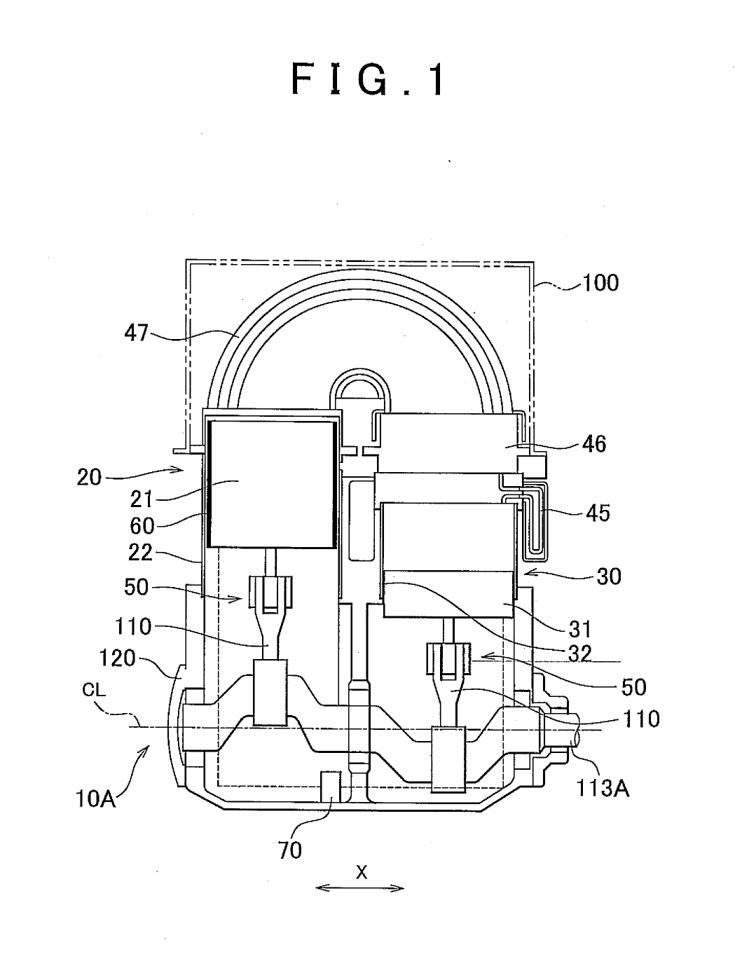

FIG. 1 is a schematic diagram showing a Stirling engine 10A according to this embodiment. The Stirling engine 10A is a two-cylinder α-type Stirling engine. The Stirling engine 10A includes two cylinder portions, namely a high-temperature side cylinder portion 20 and a low-temperature side cylinder portion 30, which are disposed in parallel series such that an extension direction of a crank axis CL and a cylinder arrangement direction X are parallel to each other. The high-temperature side cylinder portion 20 includes an expansion piston 21 and a high-temperature side cylinder 22, while the low-temperature side cylinder portion 30 includes a compression piston 31 and a low-temperature side cylinder 32. The compression piston 31 is provided at a phase difference to the expansion piston 21 so as to move at a delay of approximately 90°, in terms of a crank angle, relative to the expansion piston 21.

An upper portion space of the high-temperature side cylinder 22 serves as an expansion space. The expansion space is a working space formed in accordance with the expansion piston 21, into which working fluid heated by a heater 47 flows. More specifically, in this embodiment, the heater 47 is disposed in the interior of an exhaust pipe 100 provided in an internal combustion engine (to be referred to hereafter as a vehicle engine), not shown in the drawing, which is installed in a vehicle. In the heater 47, the working fluid is heated by thermal energy recovered from exhaust gas serving as a fluid constituting a high-temperature heat source. An upper portion space of the low-temperature side cylinder 32 serves as a compression space. The compression space is a working space formed in accordance with the compression piston 31, into which working fluid cooled by a cooler 45 flows. A regenerator 46 performs heat exchange on the working fluid reciprocating between the expansion space and the compression space. More specifically, when the working fluid flows into the compression space from the expansion space, the regenerator 46 receives heat from the working fluid, and when the working fluid flows into the expansion space from the compression space, the regenerator 46 discharges stored heat to the working fluid. Air is used as the working fluid. However, the invention is not limited thereto, and a gas such as He, H₂, or N₂, for example, may be used as the working fluid.

Next, an operation of the Stirling engine 10A will be described. When the working fluid is heated by the heater 47, the working fluid expands, causing the expansion piston 21 to be pressed down, whereby a drive shaft (crankshaft) 113 rotates. When the expansion piston 21 subsequently shifts to a rising stroke, the working fluid is transferred to the regenerator 46 through the heater 47. In the regenerator 46, heat is discharged, after which the working fluid flows to the cooler 45. The working fluid cooled by the cooler 45 flows into the compression space and is compressed during the rising stroke of the compression piston 31. The compressed working fluid then takes heat from the regenerator 46 so as to increase in temperature, flows to the heater 47, and is heated and caused to expand again therein. In other words, the Stirling engine 10A is operated by the reciprocating flow of the working fluid.

Incidentally, in this embodiment, exhaust gas from the internal combustion engine of the vehicle is used as the heat source of the Stirling engine 10A, and therefore an amount of obtained heat is limited, meaning that the Stirling engine 10A must be operated within the range of the amount of obtained heat. Hence, in this embodiment, internal friction in the Stirling engine 10A is reduced as far as possible. More specifically, gas lubrication is performed between the cylinders 22, 32 and the pistons 21, 31 in order to eliminate friction loss caused by a piston ring, i.e. the type of internal friction in the Stirling engine 10A that generates the greatest friction loss.

In gas lubrication, the pistons 21, 31 are caused to float in air using air pressure (distribution) generated in a minute clearance between the cylinders 22, 32 and the pistons 21, 31. When gas lubrication is employed, sliding resistance is extremely small, and therefore internal friction in the Stirling engine 10A can be reduced greatly. Static pressure gas lubrication, in which pressurized fluid is ejected and an object is caused to float by static pressure generated as a result, for example, may be employed as gas lubrication for causing an object to float in air. However, the invention is not limited thereto, and dynamic pressure gas lubrication, for example, may be employed as the gas lubrication.

With regard to this point, a booster pump 70 serving as pressurized fluid supply means for supplying pressurized fluid into the interior of the pistons 21, 31 is provided in a crank case 120 of the Stirling engine 10A, whereby the pistons 21, 31 are subjected to static pressure gas lubrication using the booster pump 70. More specifically, the booster pump 70 pressurizes the working fluid and supplies the pressurized working fluid to the interior of the pistons 21, 31 as pressurized fluid. The pressurized fluid introduced into the interior of the pistons 21, 31 is ejected through a plurality of air supply holes (not shown) penetrating from the interior of the piston 21 to an outer peripheral surface, and as a result, static pressure gas lubrication is performed.

A clearance of several tens of μm is formed between the cylinders 22, 32 and the pistons 21, 31 on which gas lubrication is performed. The working fluid of the Stirling engine 10A exists within this clearance. The pistons 21, 31 are supported in a non-contact state or an allowable contact state with the cylinders 22, 32, respectively, by the gas lubrication. Accordingly, a piston ring is not provided around the pistons 21, 31 and lubricating oil typically used together with a piston ring is not employed. When gas lubrication is employed, air tightness is maintained in the expansion space and the compression space by the minute clearance, and therefore a ring-less, oil-less clearance seal is formed.

Furthermore, the pistons 21, 31 and the cylinders 22, 32 are made of metal. More specifically, in this embodiment, the corresponding pistons 21, 31 and cylinders 22, 32 are formed from metal (here, SUS) having an identical coefficient of linear expansion. Hence, even when thermal expansion occurs, an appropriate clearance can be maintained, and therefore gas lubrication can be performed.

Incidentally, with gas lubrication, a load capability is small, and therefore a side force of the pistons 21, 31 must be reduced to substantially zero. In other words, when gas lubrication is performed, the ability (pressure resistance ability) of the cylinders 22, 32 to withstand a radial direction (lateral direction, thrust direction) force decreases, and therefore a linear motion precision of the pistons 21, 31 relative to an axis of the cylinders 22, 32 must be increased.

For this purpose, a grasshopper mechanism 50 is employed in a piston/crank unit in this embodiment. A Watt mechanism, for example, may be used instead of the grasshopper mechanism 50 as a mechanism for realizing a linear motion, but a required mechanism size for obtaining an identical linear motion precision is smaller in the grasshopper mechanism 50 than in other mechanisms, and therefore an increase in the compactness of the entire apparatus can be achieved. In particular, the Stirling engine 10A according to this embodiment is disposed in a limited space under the floor of an automobile, and therefore an increase in the compactness of the entire apparatus leads to an increase in disposal freedom. Furthermore, a required mechanism weight for obtaining an identical linear motion precision is lower in the grasshopper mechanism 50 than in other mechanisms, and therefore an improvement in fuel efficiency can be achieved. Moreover, the mechanism constitution of the grasshopper mechanism 50 is comparatively simple, and therefore the grasshopper mechanism 50 can be constructed (manufactured, assembled) easily.

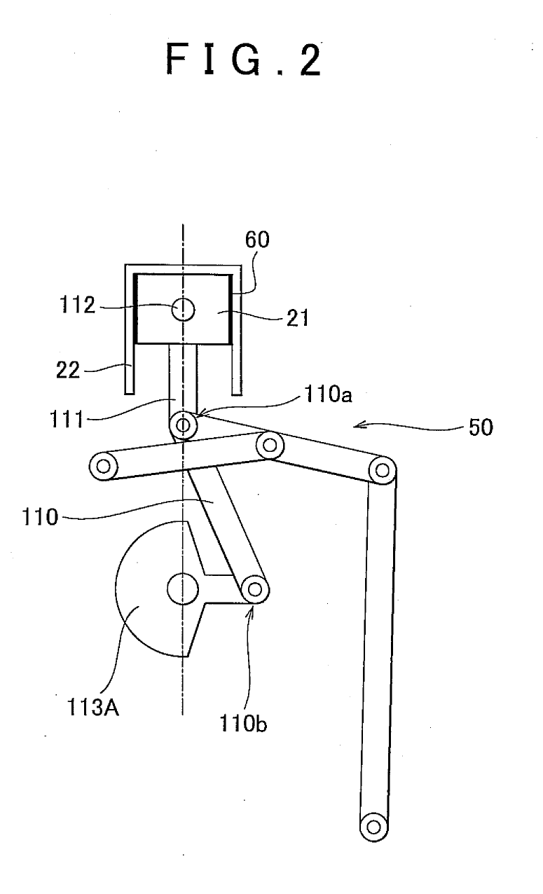

FIG. 2 is a schematic diagram showing the constitution of the piston/crank unit of the Stirling engine 10A. Note that a common constitution is employed in the piston/crank unit on the high-temperature side cylinder portion 20 side and the low-temperature side cylinder portion 30 side, and therefore only the high-temperature side cylinder portion 20 side will be described below while omitting description of the low-temperature side cylinder portion 30 side. An approximate linear mechanism includes the grasshopper mechanism 50, a connecting rod 110, an extension rod 111, and a piston pin 112. The expansion piston 21 is connected to the drive shaft 113 via the connecting rod 110, the extension rod 111, and the piston pin 112. More specifically, the expansion piston 21 is connected to one end side of the extension rod 111 via the piston pin 112, while a small end portion 110a of the connecting rod 110 is connected to another end side of the extension rod 111. A large end portion 110b of the connecting rod 110 is connected to the drive shaft 113.

A reciprocating motion of the expansion piston 21 is transmitted to the drive shaft 113 by the connecting rod 110 and converted into a rotary motion. The connecting rod 110 is supported by the grasshopper mechanism 50 such that the expansion piston 21 is caused to perform a linear reciprocating motion. By having the grasshopper mechanism 50 support the connecting rod 110 in this manner, a side force F of the expansion piston 21 decreases to substantially zero. Hence, the expansion piston 21 can be supported sufficiently even by gas lubrication having a small load capability.

Incidentally, foreign matter such as minute pieces of metal that could not be removed completely during manufacture may remain in the interior of heat exchange devices such as the cooler 45, the regenerator 46, and the heater 47. Further, minute pieces of metal may peel away from the regenerator 46, which has a built-in wire mesh, during an engine operation and fall as foreign matter. When the Stirling engine 10A is operated, this foreign matter flows into the expansion space and compression space together with the working fluid. The foreign matter may also infiltrate the clearance between the pistons 21, 31 and the cylinders 22, 32, and in the clearance the foreign matter may grow and agglutinate. Hence, in the Stirling engine 10A, which reaches a high temperature, the effects of thermal expansion and temperature must be taken into account, making it difficult to manage the clearance. As a measure against agglutination in this high-temperature environment, a layer 60 is provided on an outer peripheral surface of the expansion piston 21.

The layer 60 is formed from a resin coating. The resin is a flexible material having a higher linear expansion coefficient than a base material of the metallic expansion piston 21. More specifically, in this embodiment, the resin is a fluorine-based resin. The linear expansion coefficient of resin is typically around four to ten times greater than that of metal, and it is therefore difficult to apply resin to the outer peripheral surface of the expansion piston 21, the radial clearance of which is approximately several tens of μm. The linear expansion coefficient of the layer 60 is set such that the clearance formed with the high-temperature side cylinder 22 can be reduced in accordance with a temperature increase.

A thickness of the layer 60 at a normal temperature is set to be equal to or greater than the radial clearance. In this embodiment, the thickness of the layer 60 is further set to be at least twice the radial clearance. This thickness is realized in the layer 60 by forming several overlapping resin coatings. Furthermore, the thickness of the layer 60 at a normal temperature is set such that even when thermal expansion occurs under use conditions, the clearance formed with the high-temperature side cylinder 22 can be maintained. With regard to this point, the temperature of the working fluid varies from atmospheric temperature to several hundred ° C., a minimum normal temperature is approximately −40° C., for example, and a maximum use temperature is approximately 400° C., for example.

As noted above, metal (here, SUS) having an identical linear expansion coefficient is applied to both the expansion piston 21 and the high-temperature side cylinder 22. Hence, although the radial clearance of the metallic portion remains substantially unvaried following thermal expansion, the thickness of the layer 60, which has a higher linear expansion coefficient than the metal, increases following thermal expansion, and as a result, the radial clearance decreases following thermal expansion. Meanwhile, the foreign matter that can infiltrate the radial clearance is basically limited to smaller foreign matter than the radial clearance at a normal temperature, and even in an exceptional case where the layer 60 contacts the high-temperature side cylinder 22, the maximum size of the foreign matter is approximately twice the radial clearance.

Even when foreign matter infiltrates the radial clearance and exists between the expansion piston 21 (more accurately, the layer 60) and the high-temperature side cylinder 22, the interposed foreign matter is swallowed and trapped by the layer 60 during thermal expansion, for example, due to the flexibility of the layer 60. When the expansion piston 21 (more accurately, the layer 60) approaches, or in certain cases contacts, the high-temperature side cylinder 22 during a subsequent engine operation, the foreign matter is embedded in the flexible layer 60. Hence, an increase in surface pressure caused by the interposed foreign matter is prevented, and as a result, agglutination can be prevented. Further, even when the infiltrating foreign matter joins together and grows, infiltration and growth of the foreign matter can be permitted to an extent at which the foreign matter reaches a size equaling a sum of the radial clearance and the thickness of the layer 60. Moreover, since the layer 60 is formed from a fluorine-based resin, which is a material that functions as a solid lubricant, agglutination caused by the layer 60 itself can be prevented.

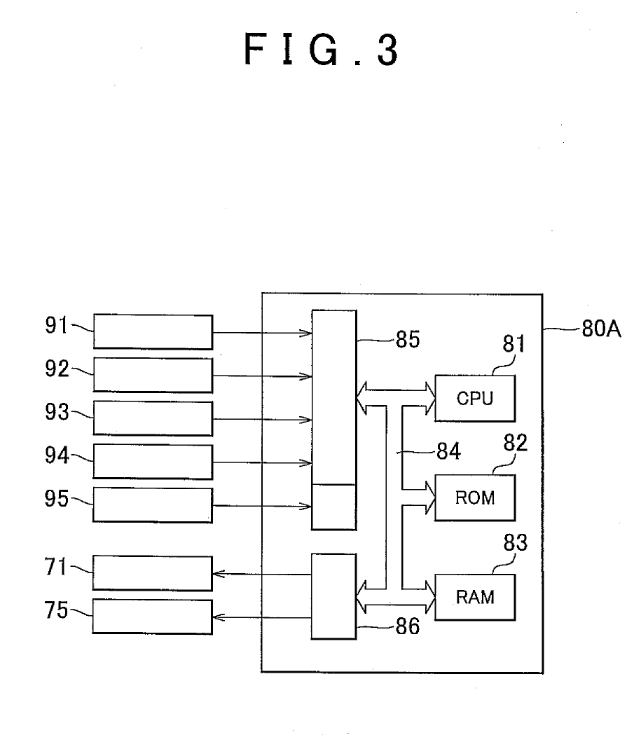

The Stirling engine 10A is further provided with an ECU 80A shown in FIG. 3. The ECU 80A includes a microcomputer constituted by a central processing unit (CPU) 81, a read-only memory (ROM) 82, a random access memory (RAM) 83, and so on, and input/output circuits 85, 86. These constitutions are connected to each other via a bus 84. Various sensors and switches, such as a rotation speed N_{SE} detection sensor 91 for detecting rotation speed N_{SE} of the Stirling engine 10A, a temperature sensor 92 for detecting a high-temperature side working fluid temperature Tₕ, i.e. the temperature of the working fluid in the expansion space, a rotation speed Nₑ detection sensor 93 for detecting a rotation speed Nₑ of the vehicle engine, an air flow meter 94 for measuring an intake air amount Gₐ of the vehicle engine, and an exhaust gas temperature sensor 95 for detecting an exhaust gas temperature Tᵢₙ immediately before heat exchange is performed with the heater 47, are electrically connected to the ECU 80A. The booster pump 70 and a pressure pump 75 for pumping cooling water to the cooler 45, for example, are electrically connected to the ECU 80A as control subjects. Note that the rotation speed Nₑ detection sensor 93, the air flow meter 94, and the exhaust gas temperature sensor 95 may be connected indirectly via a vehicle engine ECU, not shown in the drawings, for example. Further, the ECU 80A may be realized by a vehicle engine ECU, for example.

The ROM 82 stores programs describing various types of processing executed by the CPU 81, map data, and so on. On the basis of the programs stored in the ROM 82, the CPU 81 executes the processing while using a temporary storage area of the RAM 83 as required. As a result, various control means, determining means, detecting means, calculating means, and so on are realized functionally by the ECU 80A.

For example, control means for performing control to prevent the expansion piston 21 from contacting the high-temperature side cylinder 22 when an engine operation is stopped until a temperature Tₚ of the expansion piston 21 can be suppressed below a predetermined value γ (300° C., for example) serving as a heat resistance temperature of the layer 60 is realized functionally by the ECU 80A. More specifically, the control means is realized to perform control for starting an operation to stop the engine operation when a heat supply from the high-temperature heat source is stopped, and then causing the expansion piston 21 to contact the high-temperature side cylinder 22 in a state where the engine operation is stopped and a piston temperature T_{pb} serving as the temperature of the expansion piston 21 following contact with the high-temperature side cylinder 22 can be suppressed below the predetermined value γ. More specifically, the heat supply from the high-temperature heat source is stopped when the vehicle engine stops. Further, following contact between the expansion piston 21 and the high-temperature side cylinder 22, the piston temperature T_{pb} reaches a maximum temperature that can be attained due to temperature increases in the expansion piston 21. Furthermore, when the operation to stop the engine operation begins, the control means performs control to halt the flow of cooling water to the cooler 45. Moreover, during the control to cause the expansion piston 21 to contact the high-temperature side cylinder 22, the control means perform control to stop the booster pump 70.

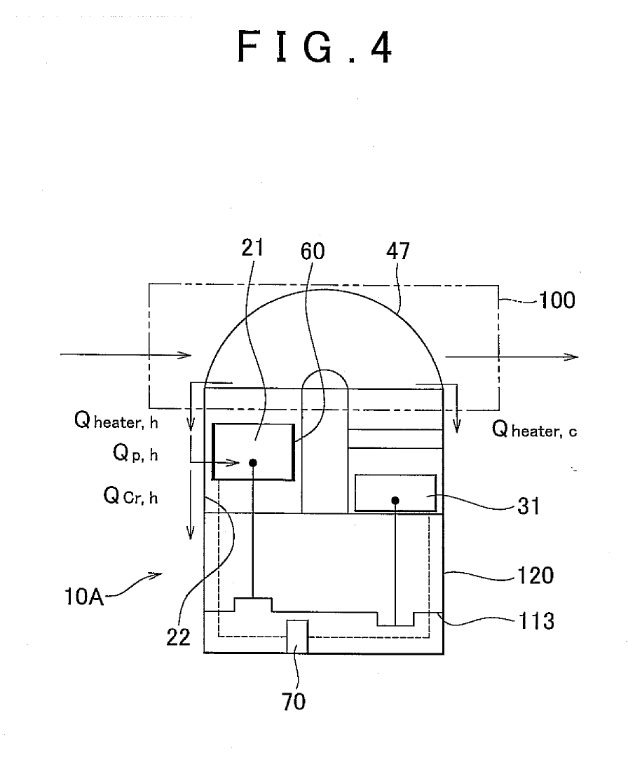

Further, estimating means for estimating the piston temperature T_{pb} is realized functionally by the ECU 80A. More specifically, the piston temperature T_{pb} is estimated on the basis of a following calculation method. Here, FIG. 4 shows a conduction path of the heat stored in the heater 47. Qₕₑₐₜₑᵣ is an amount of heat stored in the heater 47, which is calculated using a following Equation (1).

Qₕₑₐₜₑᵣ=mₕₑₐₜₑᵣ×cₕₑₐₜₑᵣ×(Tₕₑₐₜₑᵣ−T₀) (1)

Here, mₕₑₐₜₑᵣ denotes a mass of the heater 47, cₕₑₐₜₑᵣ denotes a specific heat of the heater 47, Tₕₑₐₜₑᵣ denotes an average temperature of the heater 47, and T₀ denotes the atmospheric temperature.

Meanwhile, Qₕₑₐₜₑᵣ is expressed by a following Equation (2).

Qₕₑₐₜₑᵣ=Q_{heater,h}+Q_{heater,c} (2)

Here, Q_{heater,h} denotes an amount of heat conducted to the high-temperature side cylinder portion 20 side and Q_{heater,c} denotes an amount of heat conducted to the low-temperature side cylinder portion 30 side. Further, Q_{heater,h} is expressed by a following Equation (3).

Q_{heater,h}=Q_{p,h}+Q_{Cr,h} (3)

Here, Q_{p,h} denotes an amount of heat conducted to the expansion piston 21 and Q_{Cr,h} denotes an amount of heat conducted to the crank case 120.

Further, Q_{p,h} is expressed by a following Equation (4).

Q_{p,h}=mₚ×Cₚ×ΔTₚ (4)

Here, mₚ denotes a mass of the expansion piston 21, Cₚ denotes a specific heat of the expansion piston 21, and ΔTₚ denotes a temperature increase following contact between the expansion piston 21 and the high-temperature side cylinder 22. The piston temperature T_{pb} is expressed by a following Equation (5).

T_{pb}=Tₚₐ+ΔTₚ (5)

Here, Tₚₐ denotes the temperature of the expansion piston 21 prior to contact with the high-temperature side cylinder 22.

With regard to these points, a ratio of Q_{heater,h} to Q_{heater,c} in Equation (2) and a ratio of Q_{p,h} to Q_{Cr,h} in Equation (3) are determined in accordance with a hardware constitution of the Stirling engine 10A and a cooling water temperature of the cooler 45. Accordingly, the ratio of Q_{heater,h} to Q_{heater,c} and the ratio of Q_{p,h} to Q_{Cr,h} can be defined by constants or map data. Hence, if Qₕₑₐₜₑᵣ is known, Q_{p,h} can be learned from Equation (2) and Equation (3) and ΔTₚ can be learned from Equation (4). Further, if Tₕₑₐₜₑᵣ is known, Qₕₑₐₜₑᵣ can be learned from Equation (1). Tₚₐ can be defined in accordance with operating conditions of the Stirling engine 10A, for example, using map data. As a result, the piston temperature T_{pb} can be estimated on the basis of Equation (5). In this embodiment, contact avoiding means is realized by the booster pump 70 and the ECU 80A.

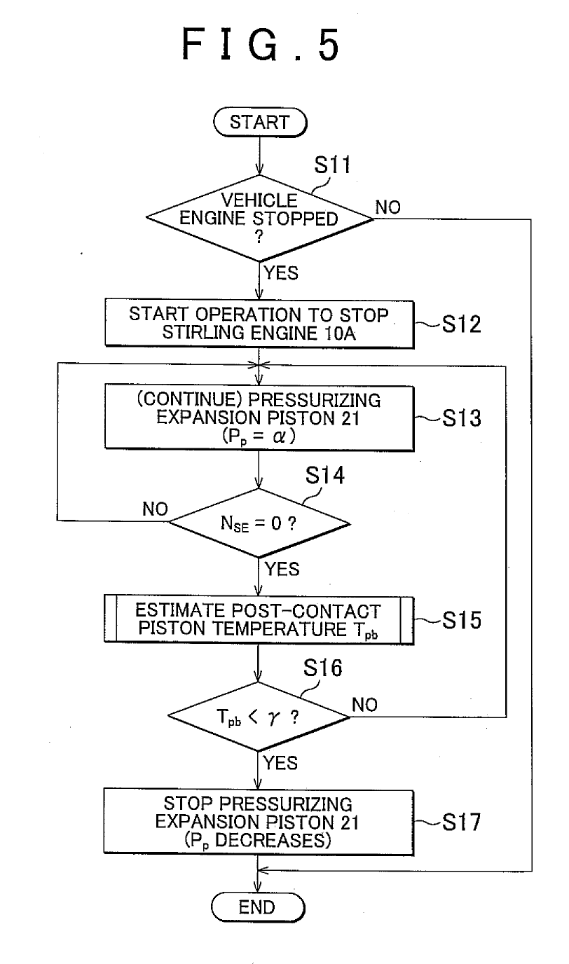

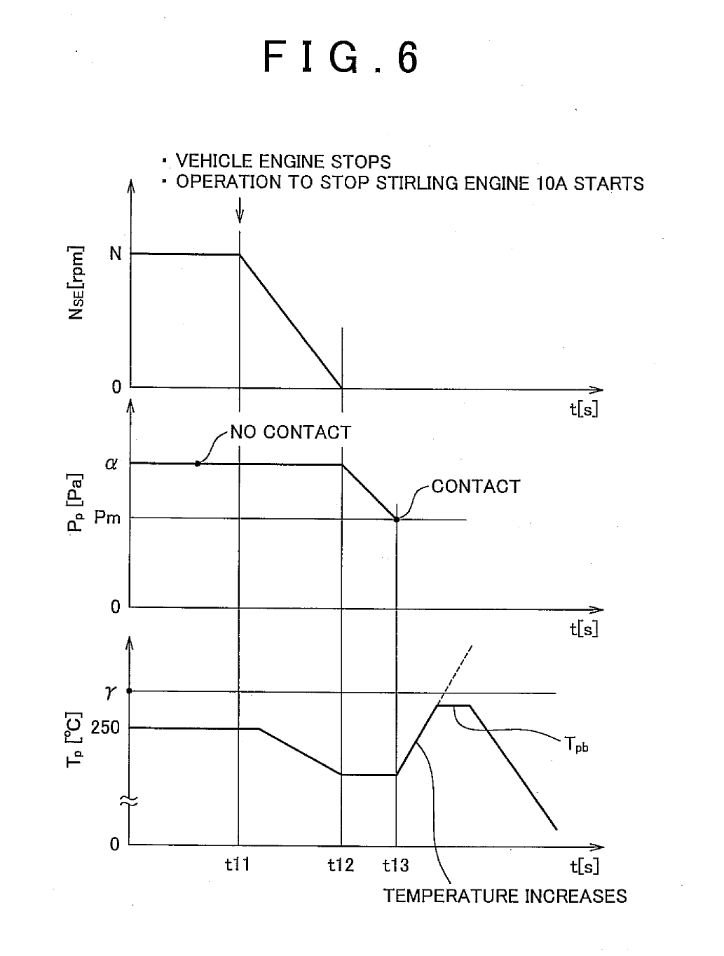

Next, an operation of the ECU 80A will be described using a flowchart shown in FIG. 5 and a timing chart shown in FIG. 6. The ECU 80A determines whether or not the vehicle engine is stopped (step S11). When the determination is negative, no special processing is required and therefore the flowchart is temporarily terminated. When an affirmative determination is made in step S11, on the other hand, the ECU 80A begins an operation to stop the Stirling engine 10A (step S12). Accordingly, as shown in FIG. 6, the rotation speed N_{SE}, of the Stirling engine 10A begins to decrease at a time t11.

Next, the ECU 80A continues to pressurize the interior of the expansion piston 21 by operating the booster pump 70 such that a piston internal pressure Pₚ, i.e. the internal pressure of the expansion piston 21, reaches a predetermined value α (step S13). In other words, static pressure gas lubrication is continued. Next, the ECU 80A determines whether or not the rotation speed N_{SE} of the Stirling engine 10A is zero (step S14). When the determination is negative, the routine returns to step S13 until an affirmative determination is made. Meanwhile, as shown in FIG. 6, the piston temperature Tₚ, i.e. the temperature of the expansion piston 21, begins to decrease gradually in the Stirling engine 10A, to which the heat supply from the high-temperature heat source has been stopped.

When an affirmative determination is made in step S14, on the other hand, it is determined that the Stirling engine 10A has stopped operating. At this time, the ECU 80A estimates the piston temperature T_{pb} (step S15). Note that a subroutine for estimating the piston temperature T_{pb} will be described specifically from a fifth embodiment onward. Next, the ECU 80A determines whether or not the estimated piston temperature T_{pb} is lower than the predetermined value γ (step S16). When the determination is negative, the routine returns to step S13 until an affirmative determination is made. When an affirmative determination is made in step S16, on the other hand, the ECU 80A halts the operation of the booster pump 70, whereby pressurization of the interior of the expansion piston 21 is stopped (step S17).

In the Stirling engine 10A, as shown in FIG. 6, the operation of the Stirling engine 10A stops completely at a time t12, and since the estimated piston temperature T_{pb} is already lower than the predetermined value γ at this time, pressurization of the interior of the expansion piston 21 is stopped at the time t12. As a result, the internal piston pressure Pₚ begins to decrease from the time t12. The internal piston pressure Pₚ settles at a working fluid average pressure Pₘ at a subsequent time t13, and at this time, the expansion piston 21 and the high-temperature side cylinder 22 come into contact.

Once the expansion piston 21 and the high-temperature side cylinder 22 have come into contact, the piston temperature Tₚ begins to rise. In the Stirling engine 10A, however, pressurization of the interior of the expansion piston 21 is stopped, causing the expansion piston 21 to contact the high-temperature side cylinder 22, when the estimated piston temperature T_{pb} is lower than the predetermined value γ, or in other words in a state where the piston temperature T_{pb} can be suppressed below the predetermined value γ. Hence, in the Stirling engine 10A, a situation in which the piston temperature Tₚ exceeds the predetermined value γ following contact between the expansion piston 21 and the high-temperature side cylinder 22, thereby damaging the layer 60, as shown by a broken line in FIG. 6, for example, can be prevented, and as a result, reliability can be secured in the expansion piston 21. Further, in the Stirling engine 10A, the expansion piston 21 is caused to contact the high-temperature side cylinder 22 in a state where the engine operation is stopped, and therefore damage to the layer 60 caused by sliding can also be prevented.

### Second Embodiment

A Stirling engine 10B according to this embodiment is substantially identical to the Stirling engine 10A except that an ECU 8013 is provided in place of the ECU 80A. The ECU 80B is substantially identical to the ECU 80A except that the control means is realized in a manner to be described below. Accordingly, illustration of the Stirling engine 10B has been omitted. Likewise in the ECU 8013, the control means is realized to perform control for preventing the expansion piston 21 from contacting the high-temperature side cylinder 22 until the temperature Tₚ of the expansion piston 21 can be suppressed below the predetermined value γ while the engine operation is stopped. However, in the ECU 80B, the control means is realized to perform control for continuing the engine operation using the heat stored in the heater 47, i.e. received heat, after the heat supply from the high-temperature heat source is stopped until the piston temperature T_{pb} can be suppressed below the predetermined value γ, and then beginning the operation to stop the engine operation such that the expansion piston 21 is caused to contact the high-temperature side cylinder 22 in a state where the engine operation is stopped. Note that the control performed to start the operation for stopping the engine operation and the control for causing the expansion piston 21 to contact the high-temperature side cylinder 22 are similar to those of the ECU 80A. In this embodiment, the contact avoiding means is realized by the booster pump 70 and the ECU 80B.

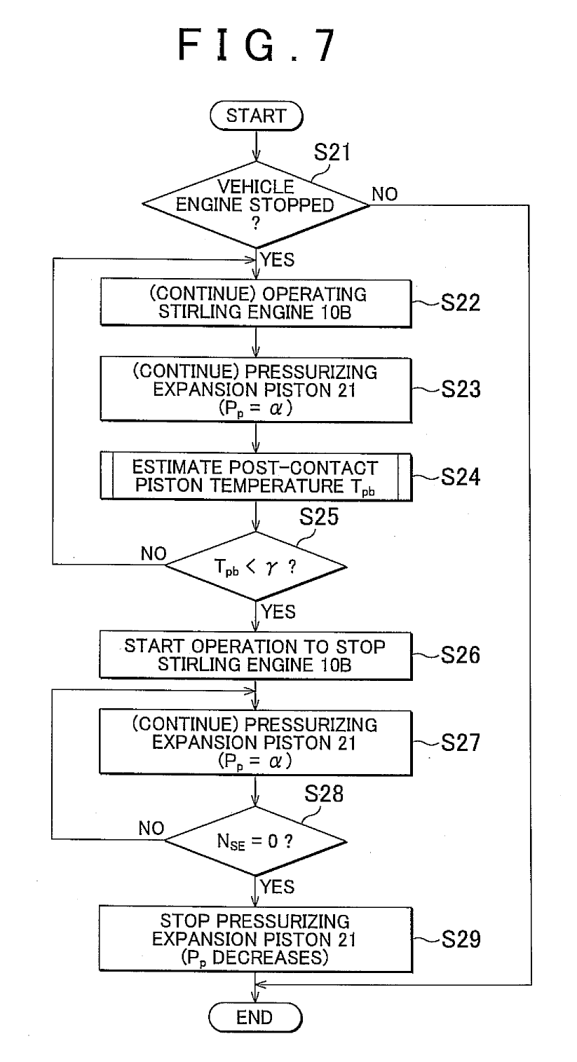

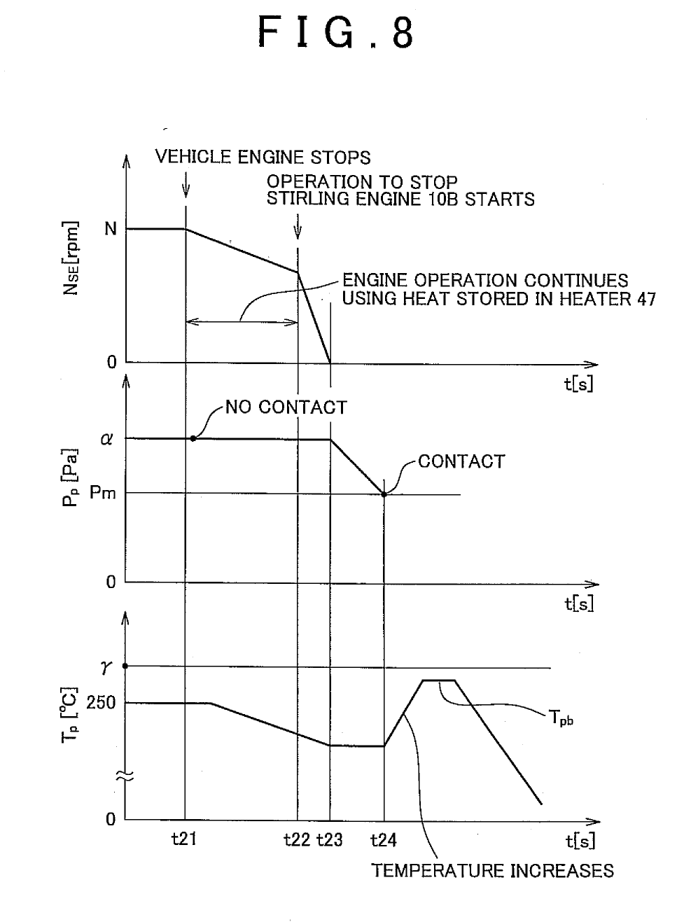

Next, an operation of the ECU 80B will be described using a flowchart shown in FIG. 7 and a timing chart shown in FIG. 8. The ECU 80B determines whether or not the vehicle engine is stopped (step S21). When the determination is negative, the flowchart is temporarily terminated, and when the determination is affirmative, the operation of the Stirling engine 10B (step S22) and pressurization of the interior of the expansion piston 21 (step S23) are continued. When the vehicle engine is stopped, the heat supply from the high-temperature heat source is halted, and therefore, as shown in FIG. 8, the rotation speed N_{SE} of the Stirling engine 10B begins to decrease at a time t21. The piston temperature Tₚ begins to fall thereafter.

After step S23, the ECU 80B estimates the piston temperature T_{pb} (step S24) and determines whether or not the estimated piston temperature T_{pb} is lower than the predetermined value γ (step S25). When a negative determination is made, the routine returns to step S22 until an affirmative determination is made. Meanwhile, as shown in FIG. 8, the Stirling engine 10B continues to operate using the heat stored in the heater 47. When an affirmative determination is made in step S25, on the other hand, the ECU 80B begins an operation to stop the Stirling engine 10B (step S26). Accordingly, as shown in FIG. 8, the rotation speed N_{SE} of the Stirling engine 10B begins to decrease further at a time t22.

Meanwhile, the ECU 80B determines whether or not the rotation speed N_{SE}, of the Stirling engine 10B is zero (step S28) while continuing to pressurize the interior of the expansion piston 21 (step S27). When the determination is negative, the routine returns to step S27 until an affirmative determination is made. When an affirmative determination is made in step S28, on the other hand, the ECU 80B halts pressurization of the interior of the expansion piston 21 by stopping the operation of the booster pump 70 (step S29). In the Stirling engine 10B, as shown in FIG. 8, the operation of the Stirling engine 10B stops completely and pressurization of the interior of the expansion piston 21 is stopped at a time t23. As a result, the internal piston pressure Pₚ begins to decrease from the time t23 and settles at the working fluid average pressure Pₘ at a time t24. At this time, the expansion piston 21 and the high-temperature side cylinder 22 come into contact.

Once the expansion piston 21 and the high-temperature side cylinder 22 have come into contact, the piston temperature Tₚ begins to rise. In the Stirling engine 10B, however, pressurization of the interior of the expansion piston 21 is stopped, causing the expansion piston 21 to contact the high-temperature side cylinder 22, in a state where the estimated piston temperature T_{pb} has become lower than the predetermined value γ. Hence, in the Stirling engine 10B, a situation in which the piston temperature Tₚ exceeds the predetermined value γ following contact between the expansion piston 21 and the high-temperature side cylinder 22, thereby damaging the layer 60, can be prevented, and as a result, reliability can be secured in the expansion piston 21. Further, in the Stirling engine 10B, the expansion piston 21 is caused to contact the high-temperature side cylinder 22 in a state where the engine operation is stopped, and therefore damage to the layer 60 caused by sliding can also be prevented. Moreover, in the Stirling engine 10B, the heat stored in the heater 47 is used to continue the engine operation until a state in which the piston temperature T_{pb} can be suppressed below the predetermined value γ is established, and therefore the heat stored in the heater 47 can be consumed as energy. Hence, in the Stirling engine 10B, an increase in the piston temperature Tₚ following contact between the expansion piston 21 and the high-temperature side cylinder 22 can be suppressed more favorably than in the Stirling engine 10A.

### Third Embodiment

A Stirling engine 10C according to this embodiment is substantially identical to the Stirling engine 10A except that an ECU 80C is provided in place of the ECU 80A. The ECU 80C is substantially identical to the ECU 80A except that the control means is realized in a manner to be described below. Accordingly, illustration of the Stirling engine 10C has been omitted. Likewise in the ECU 80C, the control means is realized to perform control for preventing the expansion piston 21 from contacting the high-temperature side cylinder 22 until the temperature Tₚ of the expansion piston 21 can be suppressed below the predetermined value γ while the engine operation is stopped.

However, in the ECU 80C, the control means is realized to perform control for continuing the engine operation making maximum use of the heat stored in the heater 47 after the heat supply from the high-temperature heat source is stopped, and then beginning the operation to stop the engine operation such that the expansion piston 21 is caused to contact the high-temperature side cylinder 22 in a state where the engine operation is stopped and the piston temperature T_{pb} can be suppressed below the predetermined value γ. Further, to continue the engine operation making maximum use of the heat stored in the heater 47, the control means performs control to continue the engine operation until the rotation speed N_{SE} reaches a predetermined value Nₛₜₒₚ. With regard to this point, the predetermined value Nₛₜₒₚ is set such that the operation of the Stirling engine 10C can be continued to a maximum limit using the heat stored in the heater 47. Note that the control performed to start the engine operation stoppage operation and the control for causing the expansion piston 21 to contact the high-temperature side cylinder 22 are similar to those of the ECU 80A. In this embodiment, the contact avoiding means is realized by the booster pump 70 and the ECU 80C.

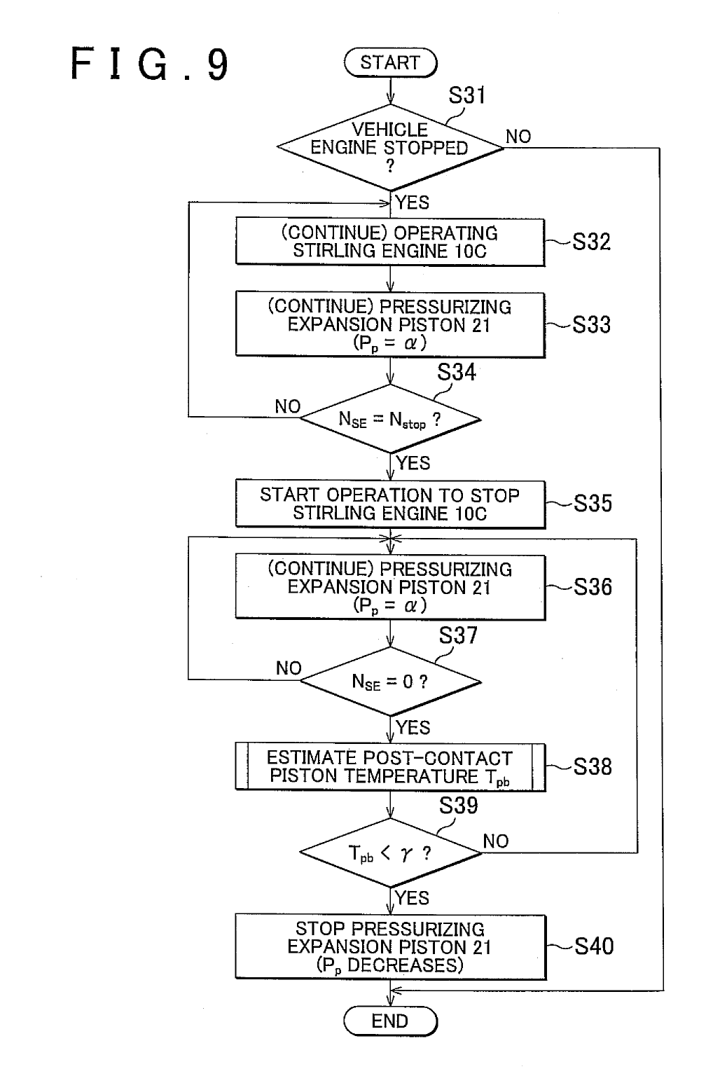

Next, an operation of the ECU 80C will be described using a flowchart shown in FIG. 9 and a timing chart shown in FIG. 10. The ECU 80C determines whether or not the vehicle engine is stopped (step S31). When the determination is negative, the flowchart is temporarily terminated, and when the determination is affirmative, the operation of the Stirling engine 10C (step S32) and pressurization of the interior of the expansion piston 21 (step S33) are continued. When the vehicle engine is stopped, the heat supply from the high-temperature heat source is halted, and therefore, as shown in FIG. 10, the rotation speed N_{SE} of the Stirling engine 10C begins to decrease at a time t31. The piston temperature Tₚ begins to fall thereafter.

After step S33, the ECU 80C determines whether or not the rotation speed N_{SE} of the Stirling engine 10C has reached the predetermined value Nₛₜₒₚ (step S34). When a negative determination is made in step S34, the routine returns to step S32 until an affirmative determination is made. When an affirmative determination is made in step S34, on the other hand, the ECU 80C begins an operation to stop the Stirling engine 10C (step S35). Accordingly, as shown in FIG. 10, the rotation speed N_{SE} of the Stirling engine 10C begins to decrease further at a time t32.

After step S35, the ECU 80C determines whether or not the rotation speed N_{SE} of the Stirling engine 10C is zero (step S37) while continuing to pressurize the interior of the expansion piston 21 (step S36). When the determination is negative, the routine returns to step S36 until an affirmative determination is made. When an affirmative determination is made in step S37, on the other hand, the ECU 80C estimates the piston temperature T_{pb} (step S38) and determines whether or not the estimated piston temperature T_{pb} is lower than the predetermined value γ (step S39). When a negative determination is made, the routine returns to step S36 until an affirmative determination is made. When an affirmative determination is made in step S39, on the other hand, the ECU 80C halts pressurization of the interior of the expansion piston 21 by stopping the operation of the booster pump 70 (step S40).

In the Stirling engine 10C, as shown in FIG. 10, the operation of the Stirling engine 10C stops completely at a time t33, and since the estimated piston temperature T_{pb} is already lower than the predetermined value γ at this time, pressurization of the interior of the expansion piston 21 is stopped at the time t33. As a result, the internal piston pressure Pₚ begins to decrease from the time t33. The internal piston pressure Pₚ settles at the working fluid average pressure Pₘ at a subsequent time t34, and at this time, the expansion piston 21 and the high-temperature side cylinder 22 come into contact.

Once the expansion piston 21 and the high-temperature side cylinder 22 have come into contact, the piston temperature Tₚ begins to rise. In the Stirling engine 10C, however, pressurization of the interior of the expansion piston 21 is stopped, causing the expansion piston 21 to contact the high-temperature side cylinder 22, in a state where the estimated piston temperature T_{pb} is lower than the predetermined value γ. Hence, in the Stirling engine 10C, a situation in which the piston temperature Tₚ exceeds the predetermined value γ such that the layer 60 is damaged can be prevented, and as a result, reliability can be secured in the expansion piston 21. Further, in the Stirling engine 10C, the expansion piston 21 is caused to contact the high-temperature side cylinder 22 in a state where the engine operation is stopped, and therefore damage to the layer 60 caused by sliding can also be prevented. Moreover, in the Stirling engine 10C, the engine operation is continued making maximum use of the heat stored in the heater 47, and therefore an increase in the piston temperature Tₚ following contact between the expansion piston 21 and the high-temperature side cylinder 22 can be suppressed even more favorably than in the Stirling engine 10B.

### Fourth Embodiment

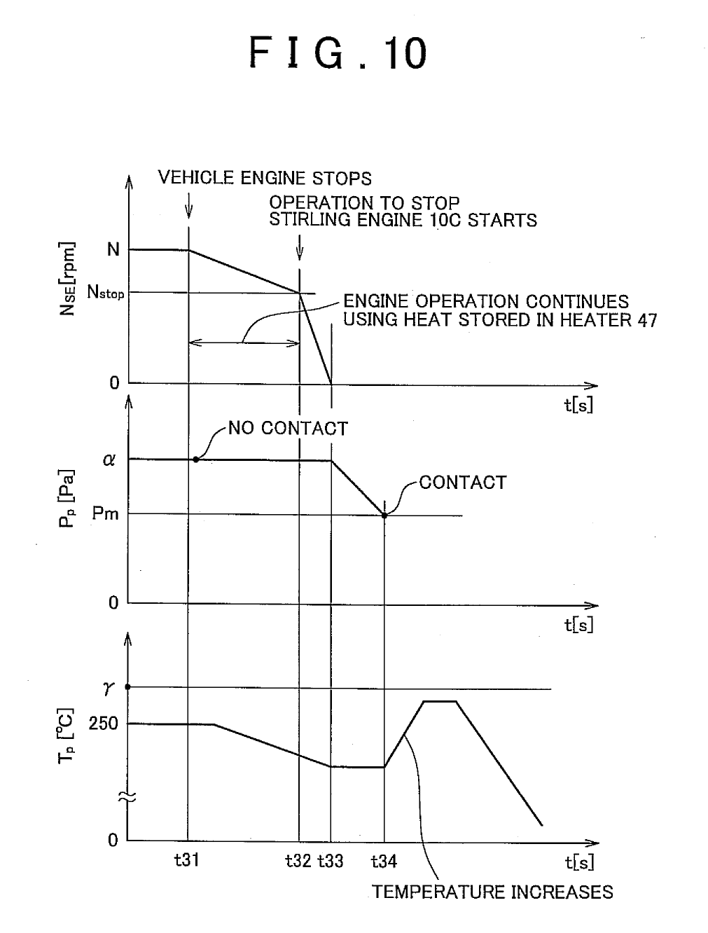

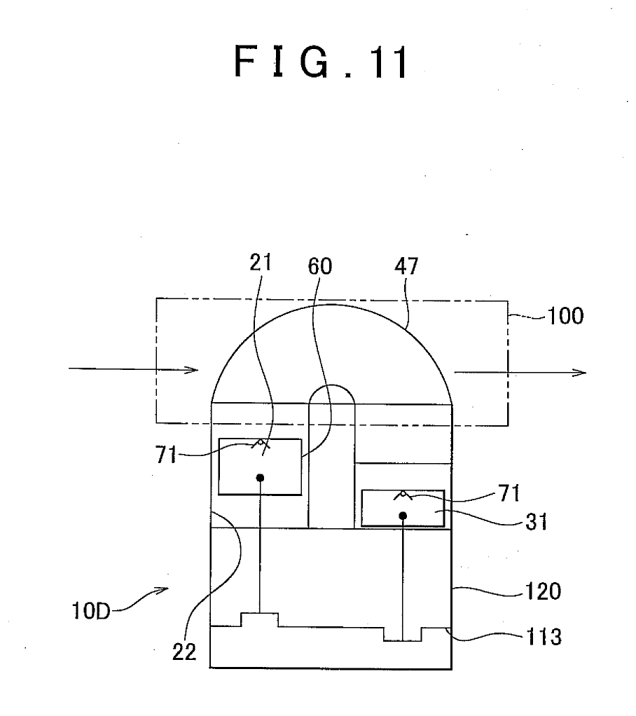

A Stirling engine 10D according to this embodiment is substantially identical to the Stirling engine 10A except that a check valve 71 is provided in each of the expansion piston 21 and the compression piston 31 in place of the booster pump 70, as shown in FIG. 11, and an ECU 80D is provided in place of the ECU 80A. The check valve 71 provided in the expansion piston 21 serves as introducing/maintaining means capable of introducing pressurized fluid into the interior of the expansion piston 21 and maintaining the introduced pressurized fluid in a pressurized state such that when gas lubrication is performed in relation to the expansion piston 21, the expansion piston 21 is subjected to static pressure gas lubrication during an engine operation using the pressure of the working fluid in the expansion space. Hence, during an operation of the Stirling engine 10D, static pressure gas lubrication is performed by supplying the working fluid in the expansion space to the interior of the expansion piston 21 as pressurized fluid via the check valve 71. Note that an open/close valve, for example, may be used as the introducing/maintaining means instead of the check valve 71. Static pressure gas lubrication is performed similarly in relation to the compression piston 31.

The ECU 80D is substantially identical to the ECU 80A except that the booster pump 70 is not electrically connected thereto and the control means is realized in a manner to be described below. Accordingly, illustration of the ECU 80D has been omitted. In the ECU 80D, the control means is realized to perform control for preventing the expansion piston 21 from contacting the high-temperature side cylinder 22 until the temperature Tₚ of the expansion piston 21 can be suppressed below the predetermined value γ when the engine operation is stopped. More specifically, the control means is realized by the ECU 80D to perform control for continuing the engine operation using the heat stored in the heater 47 after the heat supply from the high-temperature heat source is stopped until the estimated piston temperature T_{pb} can be suppressed below the predetermined value γ, and then beginning the engine operation stoppage operation such that the expansion piston 21 is caused to contact the high-temperature side cylinder 22 in a state where the engine operation is stopped. Note that the control performed to start the engine operation stoppage operation is similar to that of the ECU 80A. In this embodiment, the contact avoiding means is realized by the ECU 80D.

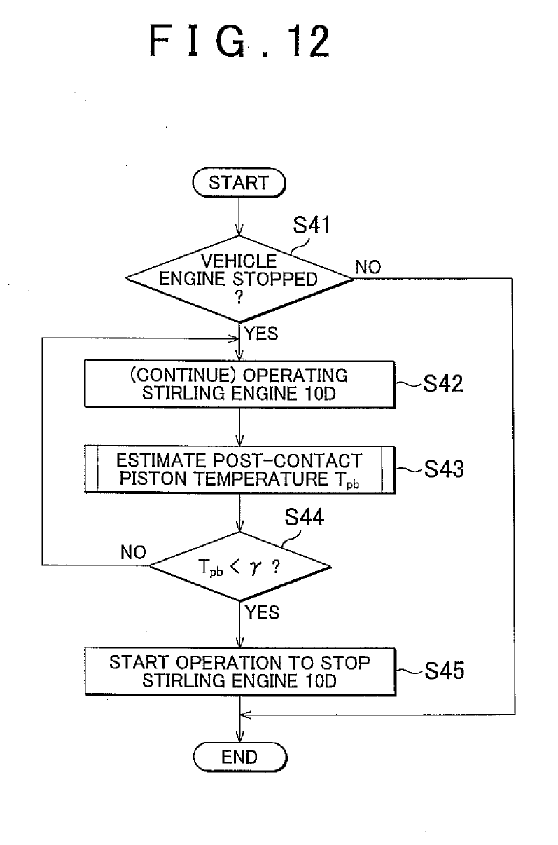

Next, an operation of the ECU 80D will be described using a flowchart shown in FIG. 12 and a timing chart shown in FIG. 13. The ECU 80D determines whether or not the vehicle engine is stopped (step S41). When the determination is negative, the flowchart is temporarily terminated, and when the determination is affirmative, the operation of the Stirling engine 10D is continued (step S42). When the vehicle engine is stopped, the heat supply from the high-temperature heat source is halted, and therefore, as shown in FIG. 13, the rotation speed N_{SE} of the Stirling engine 10D begins to decrease at a time t41. The piston temperature Tₚ begins to fall thereafter.

After step S42, the ECU 80D estimates the piston temperature T_{pb} (step S43) and determines whether or not the estimated piston temperature T_{pb} is lower than the predetermined value γ (step S44). When a negative determination is made, the routine returns to step S42 until an affirmative determination is made. Meanwhile, as shown in FIG. 13, the Stirling engine 10D continues to operate using the heat stored in the heater 47. When an affirmative determination is made in step S44, on the other hand, the ECU 80D begins an operation to stop the Stirling engine 10D (step S45). Accordingly, as shown in FIG. 13, the rotation speed N_{SE} of the Stirling engine 10D begins to decrease further at a time t42, and at a subsequent time t43, the operation of the Stirling engine 10D stops. In the Stirling engine 10D, in which static pressure gas lubrication is performed by supplying working fluid to the interior of the expansion piston 21 via the check valve 71, the internal piston pressure Pₚ reaches the working fluid average pressure Pₘ in a state where the engine operation is stopped, and at this time, the expansion piston 21 and the high-temperature side cylinder 22 come into contact.

After the expansion piston 21 and the high-temperature side cylinder 22 have come into contact, the piston temperature Tₚ begins to rise. In the Stirling engine 10D, however, the operation to halt the Stirling engine 10D is started in a state where the estimated piston temperature T_{pb} is lower than the predetermined value γ, and therefore the expansion piston 21 contacts the high-temperature side cylinder 22 while the engine operation is stopped. Hence, in the Stirling engine 10D, a situation in which the piston temperature Tₚ exceeds the predetermined value γ, thereby damaging the layer 60, can be prevented, and as a result, reliability can be secured in the expansion piston 21. Further, damage to the layer 60 caused by sliding can also be prevented. Moreover, in the Stirling engine 10D, the heat stored in the heater 47 is used to continue the engine operation until a state in which the estimated piston temperature T_{pb} can be suppressed below the predetermined value γ is established, and therefore an increase in the piston temperature Tₚ following contact between the expansion piston 21 and the high-temperature side cylinder 22 can be suppressed favorably. Furthermore, in the Stirling engine 10D, the booster pump 70 is not required to perform gas lubrication on the expansion piston 21, and therefore a favorable effect can be achieved in terms of cost.

### Fifth Embodiment

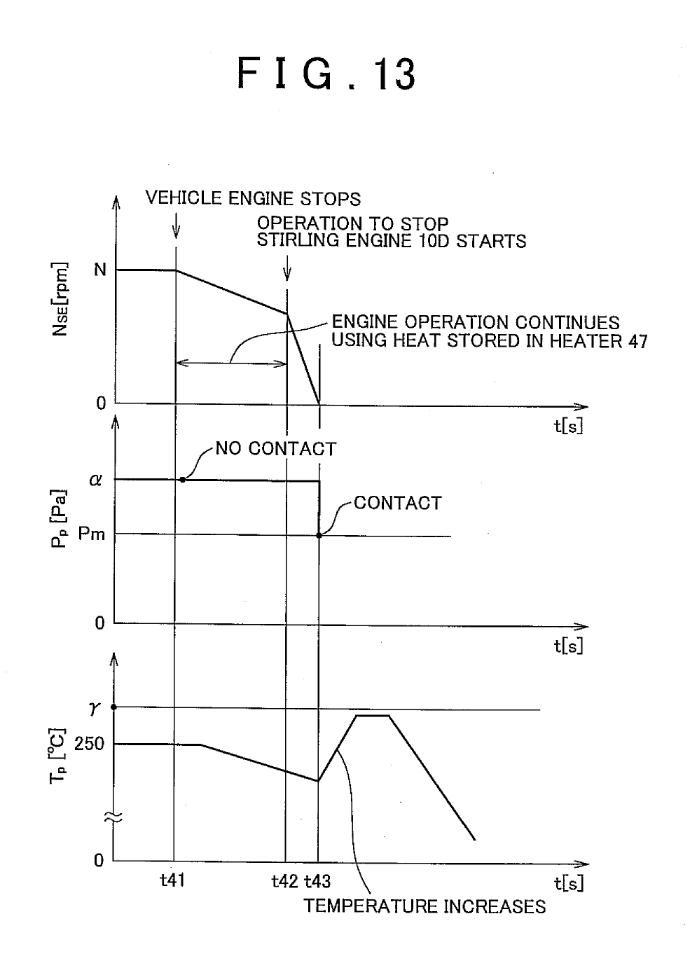

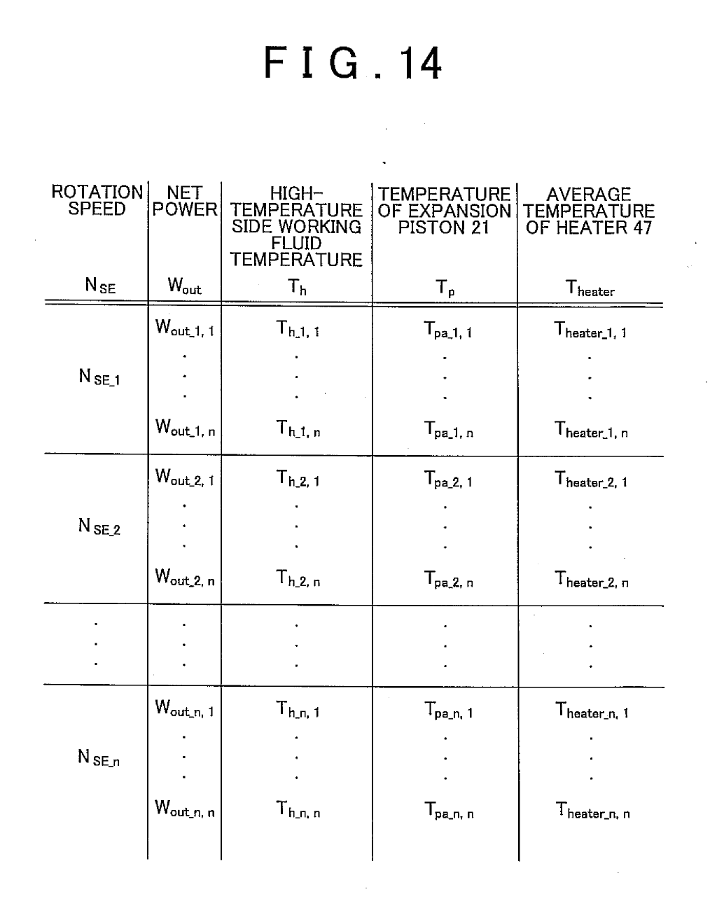

In this embodiment, a first specific example of a method for estimating the piston temperature T_{pb} will be described. Note that in this embodiment, a case in which the estimating means is realized by the ECU 80A of the Stirling engine 10A will be described. However, similar content may be applied to the respective Stirling engines described above, such as the Stirling engine 10B, for example. Specifically, when estimating the piston temperature T_{pb}, the estimating means is realized to estimate the piston temperature T_{pb} on the basis of the rotation speed N_{SE} and a net power Wₒᵤₜ of the Stirling engine 10A before the start of the engine operation stoppage operation. More specifically, the estimating means calculates the piston temperature Tₚₐ and the average temperature Tₕₑₐₜₑᵣ of the heater 47 on the basis of the rotation speed N_{SE} and the net power Wₒᵤₜ by referring to first map data shown in FIG. 14, and calculates the piston temperature T_{pb} on the basis of Equations (1) to (5) described above in the first embodiment. Note that the first map data shown in FIG. 14 are stored in advance in the ROM 82.

In the first map data, the high-temperature side working fluid temperature Tₕ, the temperature Tₚ (more specifically, Tₚₐ) of the expansion piston 21, and the average temperature Tₕₑₐₜₑᵣ of the heater 47 are preset in accordance with the rotation speed N_{SE} and the net power Wₒᵤₜ. Note that the first map data may be created on the basis of respective correlative relationships that exist between the average temperature Tₕₑₐₜₑᵣ of the heater 47 and the high-temperature side working fluid temperature Tₕ, the high-temperature side working fluid temperature Tₕ and the piston temperature Tₚ, and the piston temperature Tₚ and the net power Wₒᵤₜ. Accordingly, in this case, the temperature sensor 92 and the exhaust gas temperature sensor 95 are not required. Further, the amount of heat Qₕₑₐₜₑᵣ stored in the heater 47 may be preset in the first map data in place of the average temperature Tₕₑₐₜₑᵣ of the heater 47 by reflecting Equation (1) described above in the first embodiment under the assumption that the atmospheric temperature T₀ is fixed, for example, and this applies likewise to second to fourth map data to be described below.

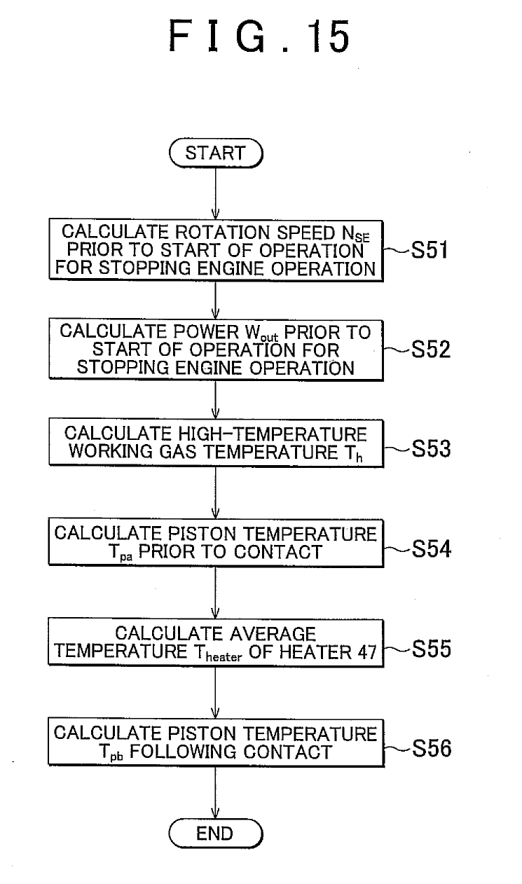

Next, an operation performed by the ECU 80A to estimate the piston temperature T_{pb} will be described using a flowchart shown in FIG. 15. Note that this flowchart is the subroutine for estimating the piston temperature T_{pb} in the flowchart shown in FIG. 5. The ECU 80A calculates the rotation speed N_{SE} (step S51) and the net power Wₒᵤₜ (step S52) before the start of the engine operation stoppage operation. Next, the ECU 80A calculates the high-temperature side working fluid temperature Tₕ, the piston temperature Tₚₐ, and the average temperature Tₕₑₐₜₑᵣ of the heater 47, in that order, on the basis of the calculated rotation speed N_{SE} and net power Wₒᵤₜ by referring to the first map data (steps S53, S54, S55). Note that these calculations may be performed on the basis of correlative relationships, for example, instead of using the first map data. After calculating the piston temperature Tₚₐ and the average temperature Tₕₑₐₜₑᵣ of the heater 47, the ECU 80A calculates the piston temperature T_{pb} on the basis of Equations (1) to (5) described above in the first embodiment (step S56).

Hence, the piston temperature T_{pb} can be estimated on the basis of the rotation speed N_{SE} and the net power Wₒᵤₜ, for example. Therefore, according to the first specific example, the piston temperature T_{pb} can be estimated regardless of the type of the high-temperature heat source by estimating the piston temperature T_{pb} on the basis of the rotation speed N_{SE} and the net power Wₒᵤₜ, and as a result, the piston temperature T_{pb} can be estimated favorably. Furthermore, according to the first specific example, required dedicated sensors such as the temperature sensor 92, for example, do not need to be provided to estimate the piston temperature T_{pb}, and therefore a favorable effect can be achieved in terms of cost.

### Sixth Embodiment

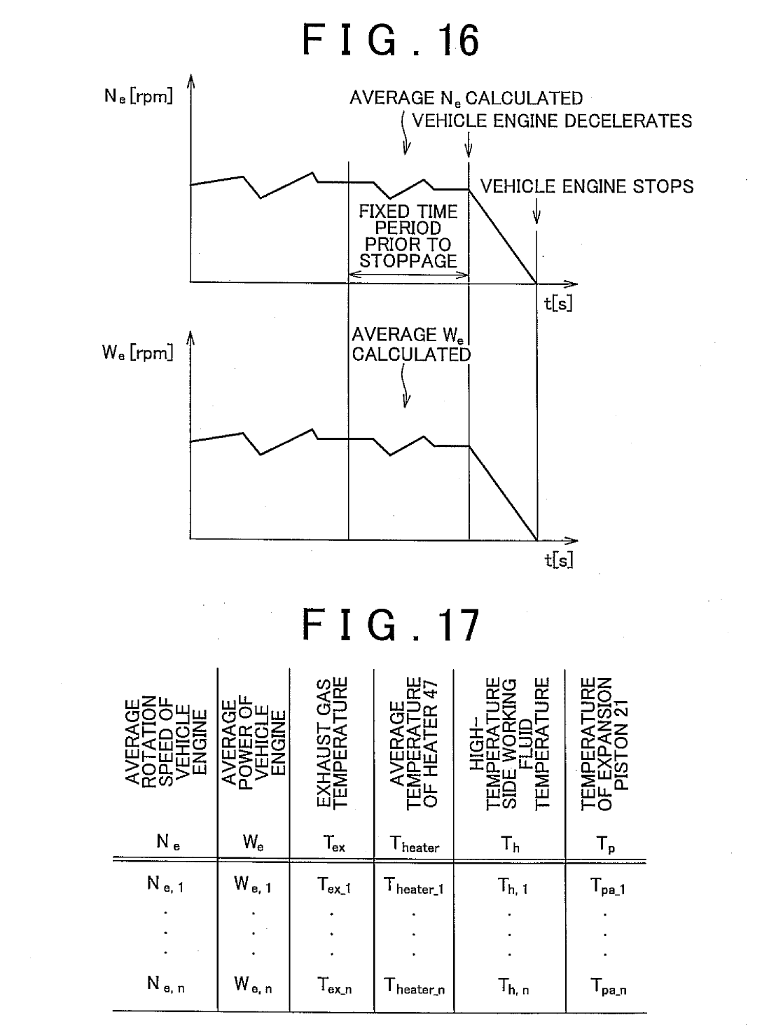

In this embodiment, a second specific example of the method for estimating the piston temperature T_{pb} will be described. Note that in this embodiment, a case in which the estimating means is realized by the ECU 80A of the Stirling engine 10A will be described. However, similar content may be applied to the respective Stirling engines described above, such as the Stirling engine 10B, for example. Specifically, when estimating the piston temperature T_{pb}, the estimating means is realized to estimate the piston temperature T_{pb} on the basis of an average load of the vehicle engine during a predetermined period prior to vehicle engine stoppage. More specifically, the average load of the vehicle engine is specified by a combination of an average rotation speed Nₑ and an average power Wₑ of the vehicle engine during the aforesaid predetermined time period. As shown in FIG. 16, the average rotation speed Nₑ and the average power Wₑ are calculated on the basis of an engine operation stoppage operation performed in relation to the vehicle engine (for example, switching an ignition switch OFF) during a predetermined period that ends when the vehicle engine begins to decelerate.

Further, the estimating means calculates the piston temperature Tₚₐ and the average temperature Tₕₑₐₜₑᵣ of the heater 47 on the basis of the average rotation speed Nₑ and the average power Wₑ by referring to second map data shown in FIG. 17, and calculates the piston temperature T_{pb} on the basis of Equations (1) to (5) described above in the first embodiment. Note that the second map data shown in FIG. 17 are stored in advance in the ROM 82. In the second map data, an exhaust gas temperature Tₑₓ, the average temperature Tₕₑₐₜₑᵣ of the heater 47, the high-temperature side working fluid temperature Tₕ, and the temperature Tₚ (more specifically, Tₚₐ) of the expansion piston 21 are preset in accordance with the average rotation speed Nₑ and the average power Wₑ. Accordingly, in this case, the temperature sensor 92 and the exhaust gas temperature sensor 95 are not required.

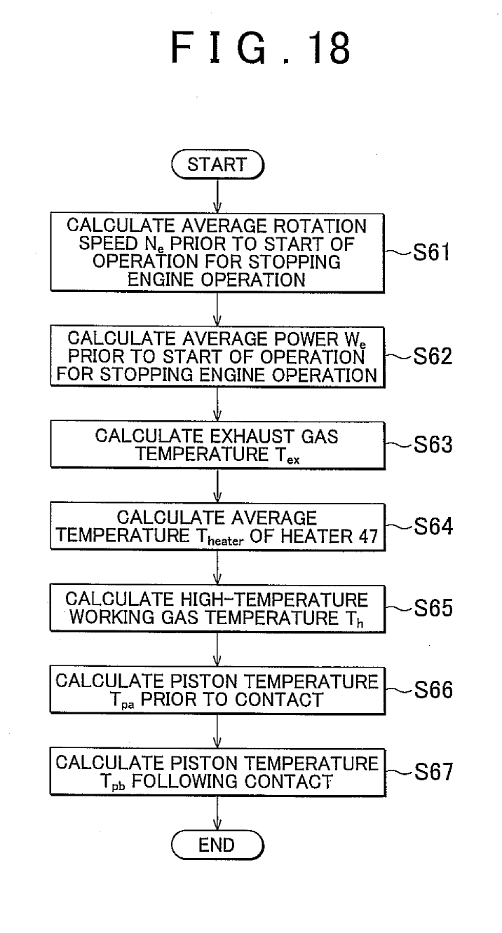

Next, an operation performed by the ECU 80A to estimate the piston temperature T_{pb} will be described using a flowchart shown in FIG. 18. The ECU 80A calculates the average rotation speed Nₑ (step S61) and the average power Wₑ (step S62) before the start of the engine operation stoppage operation. Next, the ECU 80A calculates the exhaust gas temperature Tₑₓ, the average temperature Tₕₑₐₜₑᵣ of the heater 47, the high-temperature side working fluid temperature Tₕ, and the temperature Tₚₐ of the expansion piston 21, in that order, on the basis of the calculated average rotation speed Nₑ and average power Wₑ by referring to the second map data (steps S63, S64, S65, S66). Note that these calculations may be performed on the basis of correlative relationships, for example, instead of using the second map data. After calculating the piston temperature Tₚₐ and the average temperature Tₕₑₐₜₑᵣ of the heater 47, the ECU 80A calculates the piston temperature T_{pb} on the basis of Equations (1) to (5) described above in the first embodiment (step S67).

Hence, the piston temperature T_{pb} can be estimated on the basis of the average rotation speed Nₑ and the average power Wₑ, for example. Therefore, according to the second specific example, the piston temperature T_{pb} can be estimated favorably in a case where exhaust gas from an internal combustion engine such as the vehicle engine is used as the high-temperature heat source by estimating the piston temperature T_{pb} on the basis of the average rotation speed Nₑ and the average power Wₑ. Furthermore, according to the second specific example, since required dedicated sensors such as the temperature sensor 92, for example, do not need to be provided to estimate the piston temperature T_{pb} and the ECU 80A can be realized rationally using the ECU of the vehicle engine, a favorable effect can be achieved in terms of cost.

### Seventh Embodiment

In this embodiment, a third specific example of the method for estimating the piston temperature T_{pb} will be described. Note that in this embodiment, a case in which the estimating means is realized by the ECU 80A of the Stirling engine 10A will be described. However, similar content may be applied to the respective Stirling engines described above, such as the Stirling engine 10B, for example.

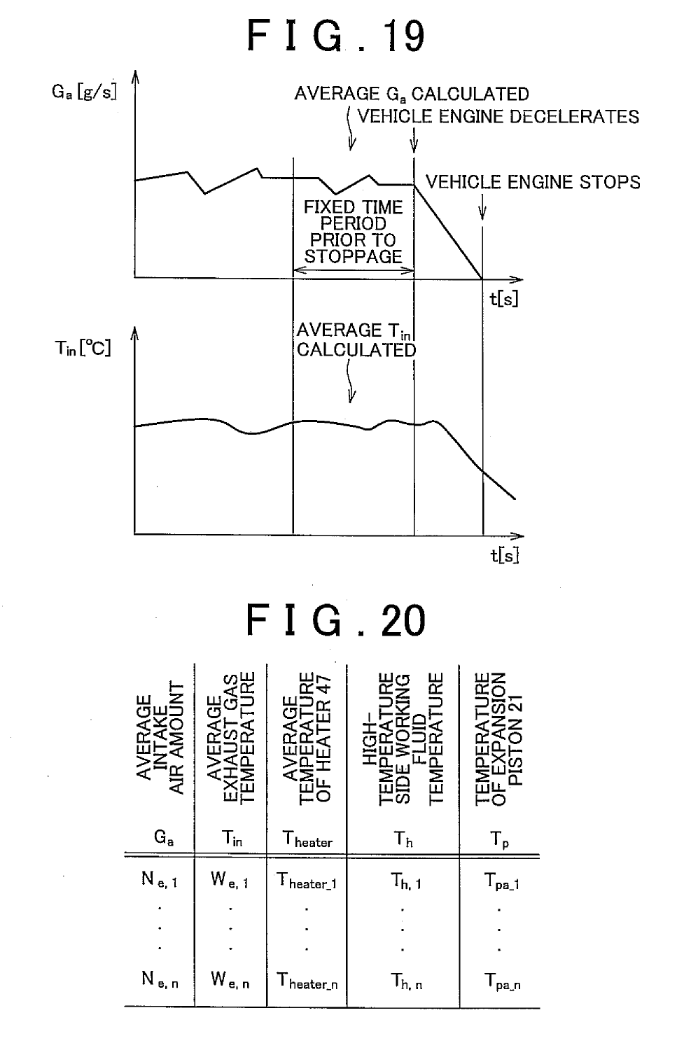

Specifically, when estimating the piston temperature T_{pb}, the estimating means is realized to estimate the piston temperature T_{pb} on the basis of the average intake air amount Gₐ and the average exhaust gas temperature Tᵢₙ of the vehicle side engine during a predetermined period prior to vehicle engine stoppage. More specifically, as shown in FIG. 19, the average intake air amount Gₐ and the average exhaust gas temperature Tᵢₙ are calculated on the basis of an engine operation stoppage operation performed in relation to the vehicle engine during a predetermined period that ends when the vehicle engine begins to decelerate. Note that the exhaust gas temperature Tᵢₙ is detected directly by the exhaust gas temperature sensor 95. Further, an average flow rate of the exhaust gas, for example, may be used instead of the average intake air amount Gₐ.

Further, the estimating means calculates the piston temperature Tₚₐ and the average temperature Tₕₑₐₜₑᵣ of the heater 47 on the basis of the average intake air amount Gₐ and the average exhaust gas temperature Tᵢₙ by referring to third map data shown in FIG. 20, and calculates the piston temperature T_{pb} on the basis of Equations (1) to (5) described above in the first embodiment. Note that the third map data shown in FIG. 20 are stored in advance in the ROM 82. In the third map data, the average temperature Tₕₑₐₜₑᵣ of the heater 47, the high-temperature side working fluid temperature Tₕ, and the temperature Tₚ (more specifically, Tₚₐ) of the expansion piston 21 are preset in accordance with the average intake air amount Gₐ and the average exhaust gas temperature Tᵢₙ. Accordingly, in this case, the temperature sensor 92 is not required.

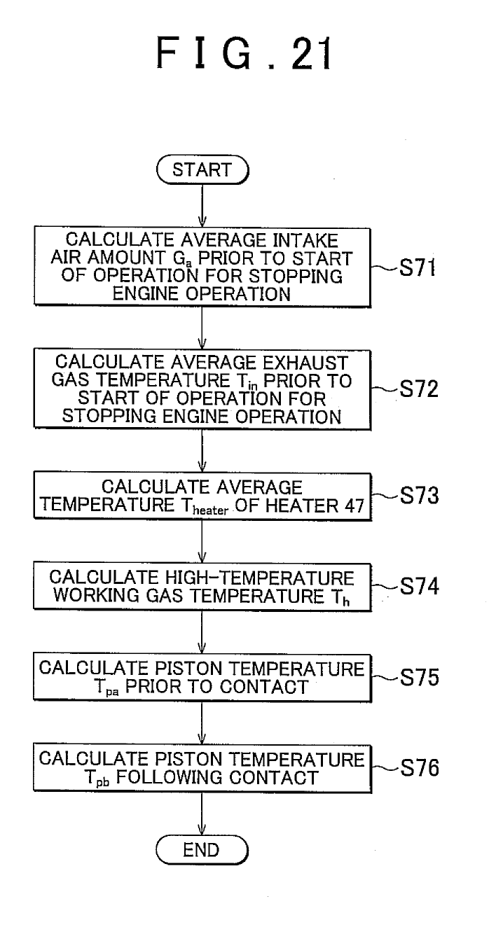

Next, an operation performed by the ECU 80A to estimate the piston temperature T_{pb} will be described using a flowchart shown in FIG. 21. The ECU 80A calculates the average intake air amount Gₐ (step S71) and the average exhaust gas temperature Tᵢₙ (step S72) before the start of the engine operation stoppage operation. Next, the ECU 80A calculates the average temperature Tₕₑₐₜₑᵣ of the heater 47, the high-temperature side working fluid temperature Tₕ, and the temperature Tₚₐ of the expansion piston 21, in that order, on the basis of the calculated average intake air amount Gₐ and average exhaust gas temperature Tᵢₙ by referring to the third map data (steps S73, S74, S75). Note that these calculations may be performed on the basis of correlative relationships, for example, instead of using the third map data. After calculating the piston temperature Tₚₐ and the average temperature Tₕₑₐₜₑᵣ of the heater 47, the ECU 80A calculates the piston temperature T_{pb} on the basis of Equations (1) to (5) described above in the first embodiment (step S76).

Hence, the piston temperature T_{pb} can be estimated on the basis of the average intake air amount Gₐ and the average exhaust gas temperature Tᵢₙ, for example. Therefore, according to the third specific example, the piston temperature T_{pb} can be estimated favorably in a case where exhaust gas from an internal combustion engine such as the vehicle engine is used as the high-temperature heat source by estimating the piston temperature T_{pb} on the basis of the average intake air amount Gₐ and the average exhaust gas temperature Tᵢₙ. Furthermore, according to the third specific example, since a required dedicated sensor such as the temperature sensor 92, for example, does not need to be provided to estimate the piston temperature T_{pb} and the ECU 80A can be realized rationally using the ECU of the vehicle engine, a favorable effect can be achieved in terms of cost.

### Eighth Embodiment

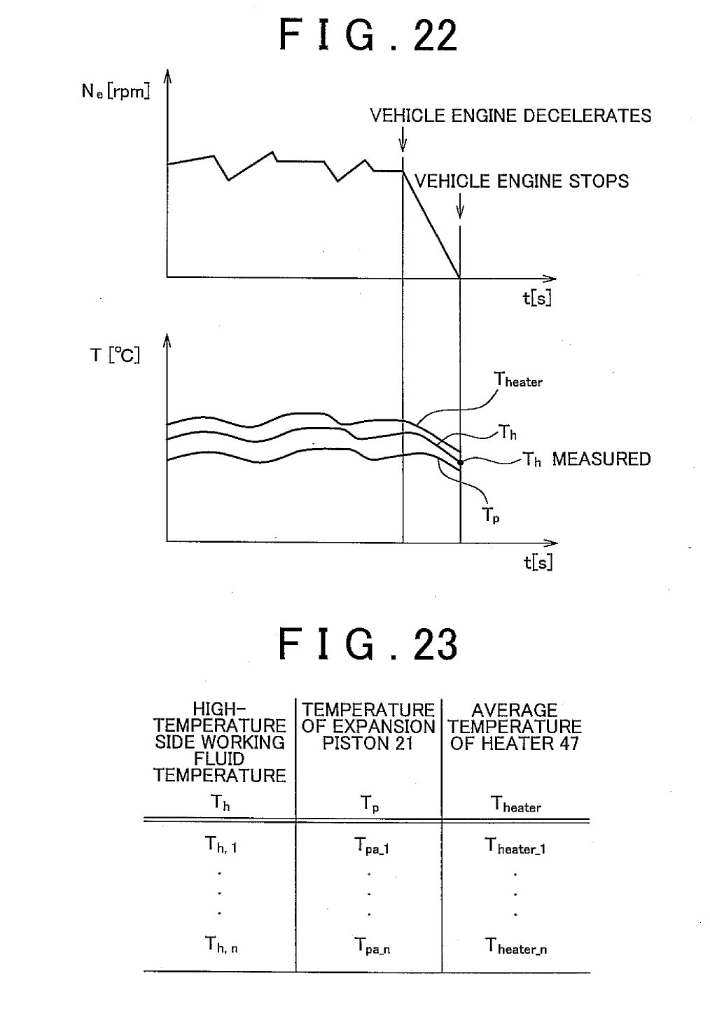

In this embodiment, a fourth specific example of the method for estimating the piston temperature T_{pb} will be described. Note that in this embodiment, a case in which the estimating means is realized by the ECU 80A of the Stirling engine 10A will be described. However, similar content may be applied to the respective Stirling engines described above, such as the Stirling engine 10B, for example. Specifically, when estimating the piston temperature T_{pb}, the estimating means is realized to estimate the piston temperature T_{pb} on the basis of the high-temperature side working fluid temperature Tₕ. In this case, a temperature detected directly on the basis of an output of the temperature sensor 92 is used as the high-temperature side working fluid temperature Tₕ. More specifically, as shown in FIG. 22, a temperature measured during a vehicle engine stoppage (a temperature measured when the heat supply from the high-temperature heat source is halted) is used.

Further, the estimating means calculates the piston temperature Tₚₐ and the average temperature Tₕₑₐₜₑᵣ of the heater 47 on the basis of the high-temperature side working fluid temperature T_{b} by referring to fourth map data shown in FIG. 23, and calculates the piston temperature T_{pb} on the basis of Equations (1) to (5) described above in the first embodiment. Note that the fourth map data shown in FIG. 23 are stored in advance in the ROM 82. In the fourth map data, the average temperature Tₕₑₐₜₑᵣ of the heater 47 and the temperature Tₚ (more specifically, Tₚₐ) of the expansion piston 21 are preset in accordance with the high-temperature side working fluid temperature Tₕ.

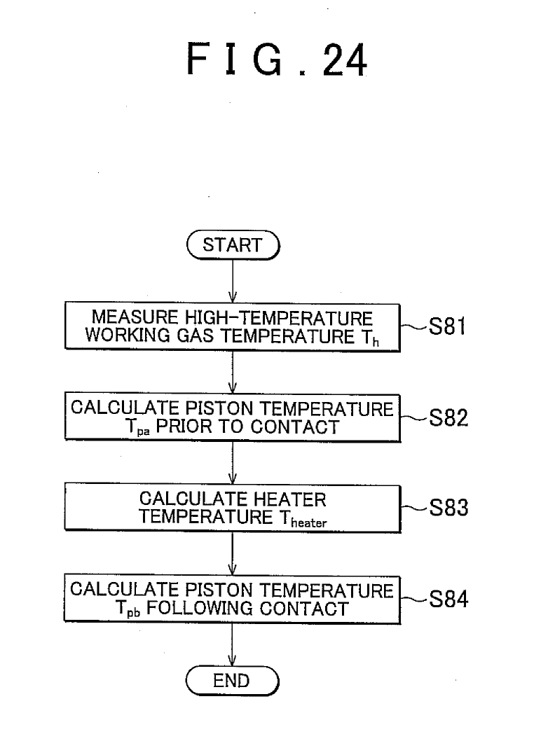

Next, an operation performed by the ECU 80A to estimate the piston temperature T_{pb} will be described using a flowchart shown in FIG. 24. The ECU 80A measures the high-temperature side working fluid temperature Tₕ during a vehicle engine stoppage (step S81). Next, the ECU 80A calculates the temperature Tₚₐ of the expansion piston 21 and the average temperature Tₕₑₐₜₑᵣ of the heater 47, in that order, on the basis of the measured high-temperature side working fluid temperature Tₕ by referring to the fourth map data (steps S82, S83). Note that these calculations may be performed on the basis of correlative relationships, for example, instead of using the fourth map data. After calculating the piston temperature Tₚₐ and the average temperature Tₕₑₐₜₑᵣ of the heater 47, the ECU 80A calculates the piston temperature T_{pb} on the basis of Equations (1) to (5) described above in the first embodiment (step S84).

Hence, the piston temperature T_{pb} can be estimated on the basis of the high-temperature side working fluid temperature Tₕ, for example. Therefore, according to the fourth specific example, the piston temperature T_{pb} can be estimated regardless of the type of the high-temperature heat source by estimating the piston temperature T_{pb} on the basis of the high-temperature side working fluid temperature Tₕ, and as a result, the piston temperature. T_{pb} can be estimated favorably. Furthermore, according to the fourth specific example, although the temperature sensor 92 is required, the map data can be simplified and the precision with which the piston temperature T_{pb} is estimated can be improved.

The embodiments described above are preferred examples of the invention. However, the invention is not limited to these embodiments and may be subjected to various modifications within a scope that does not depart from the spirit of the invention. For example, in the above embodiments, the piston temperature T_{pb} is estimated to prevent the expansion piston 21 from contacting the high-temperature side cylinder 22 until the temperature Tₚ of the expansion piston 21 can be suppressed below the predetermined value γ. However, the invention is not necessarily limited thereto, and instead, for example, a predetermined period required for a state in which the piston temperature following contact with the cylinder can be suppressed below the heat resistance temperature of the layer to be established after the heat supply from the high-temperature heat source is stopped under an arbitrary or predetermined engine operation condition may be learned in advance through experiment, whereupon the contact avoiding means prevents contact between the piston and the cylinder until the predetermined period has elapsed. Further, in the above embodiments, cases in which the layer 60 is provided over the entire outer peripheral surface of the expansion piston 21 were described. However, the invention is not limited thereto, and the layer need only be provided on a part of the outer peripheral surface of the piston. Furthermore, in the above embodiments, the various means realized functionally by the respective ECUs may be realized by other ECUs, hardware such as dedicated electronic circuits, or combinations thereof, for example.

While the various elements of the example embodiments are shown in various combinations and configurations, other combinations and configurations, including more, less or only a single element, are also within the scope of the invention.

What is claimed is:

1. A Stifling engine comprising:
a cylinder;
a piston that is subjected to gas lubrication relative to the cylinder and has a layer on an outer peripheral surface thereof, the layer being formed from a flexible material having a higher linear expansion coefficient than a base material of the piston; and
a contact avoiding device which, when an engine operation is stopped, prevents the piston from contacting the cylinder until a temperature of the piston can be suppressed below a heat resistance temperature of the layer.

2. The Stirling engine according to claim 1, wherein the contact avoiding device continues the engine operation using received heat after a heat supply to the engine from a high-temperature heat source is stopped until a temperature of the piston following contact with the cylinder can be suppressed below the heat resistance temperature of the layer, and then begins an operation to stop the engine operation such that the piston is caused to contact the cylinder in a state where the engine operation is stopped.

3. The Stirling engine according to claim 1, wherein the contact avoiding device continues the engine operation making maximum use of received heat after a heat supply to the engine from a high-temperature heat source is stopped, and then begins an operation to stop the engine operation such that the piston is caused to contact the cylinder in a state where the engine operation is stopped and a temperature of the piston following contact with the cylinder can be suppressed below the heat resistance temperature of the layer.

4. The Stirling engine according to claim 1, further comprising a check valve which, when the piston is subjected to gas lubrication, is capable of performing static pressure gas lubrication on the piston during the engine operation using a pressure of a working fluid in a working space formed in accordance with a position of the piston,
wherein the contact avoiding device continues the engine operation using received heat after a heat supply to the engine from a high-temperature heat source is stopped until a temperature of the piston following contact with the cylinder can be suppressed below the heat resistance temperature of the layer, and then begins an operation to stop the engine operation such that the piston is caused to contact the cylinder in a state where the engine operation is stopped.

5. The Stirling engine according to claim 1, further comprising an estimating device that estimates a temperature of the piston following contact with the cylinder on the basis of an output and a rotation speed prior to the start of an operation for stopping the engine operation.

6. The Stirling engine according to claim 1, wherein the Stirling engine uses exhaust gas from an internal combustion engine as a high-temperature heat source,
the Stirling engine further comprising an estimating device that estimates a temperature of the piston following contact with the cylinder on the basis of an average load of the internal combustion engine during a predetermined period prior to stoppage of the internal combustion engine.

7. The Stirling engine according to claim 1, wherein the Stirling engine uses exhaust gas from an internal combustion engine as a high-temperature heat source,
the Stirling engine further comprising an estimating device that estimates a temperature of the piston following contact with the cylinder on the basis of an average intake air amount of the internal combustion engine or an average flow rate of the exhaust gas during a predetermined period prior to stoppage of the internal combustion engine, and an average temperature of the exhaust gas of the internal combustion engine immediately prior to heat exchange.

8. The Stirling engine according to claim 1, further comprising an estimating device that estimates a temperature of the piston following contact with the cylinder on the basis of a temperature of a working fluid in a working space formed in accordance with a position of the piston.

9. A control method for a Stirling engine that includes:
a cylinder; and
a piston that is subjected to gas lubrication relative to the cylinder and has a layer on an outer peripheral surface thereof, the layer being formed from a flexible material having a higher linear expansion coefficient than a base material of the piston,
the control method comprising:
estimating a temperature of the piston attained when the piston contacts the cylinder during an engine operation stoppage, and
preventing the piston from contacting the cylinder until the estimated attained temperature of the piston can be suppressed below a heat resistance temperature of the layer.
